(19) United States
(12) Patent Application Publication
(10) Pub. No.: US 2007/0072762 A1
(43) Pub. Date: Mar. 29, 2007

(54) Method of Making Ceramic Discharge Vessels Using Stereolithography

(75) Inventors: Jeffrey T. Neil, North Reading, MA (US); Khanh Pham-Gia, Munich (DE); Berit Wessler, Taufkirchen (DE); Martin Schaefer, Berlin (DE); Martina Schwarz, Berlin (DE)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/306,607

(22) Filed: Jan. 4, 2006

Related U.S. Application Data
(60) Provisional application No. 60/596,514, filed on Sep. 29, 2005.

(51) Int. Cl. C04B 35/03; B29C 35/04; C04B 35/64

(52) U.S. Cl. 501/94; 264/401; 264/632

(57) ABSTRACT

A method of manufacturing a ceramic discharge vessel for a lamp application is described. The method uses a low viscosity suspension of ceramic powder in a liquid resin. The discharge vessel is formed layer by layer using a stereolithography system. Preferably, the layers are formed by locally exposing the ceramic-resin mixture to a UV light source that solidifies and cures the resin only in the areas which correspond to the particular cross-sectional profile of the discharge vessel for a respective layer.

### CROSS REFERENCE TO RELATED APPLICATION

This application claims the benefit of U.S. Provisional Application No. 60/596,514, filed Sep. 29, 2005.

### TECHNICAL FIELD

This invention is related to methods of making ceramic discharge vessels for high intensity discharge (HID) lamps. More particularly, this invention relates to a method of forming ceramic discharge vessels without molds or dies.

### BACKGROUND OF THE INVENTION

Discharge vessels of highly dense, light transmitting ceramic materials have proven to provide highly efficient and long-lived light sources such as metal halide and high pressure sodium lamps. The ceramics used in these applications are most commonly a highly dense and pure form of polycrystalline aluminum oxide. Other ceramics such as aluminum oxynitride, yttrium aluminum garnet, and aluminum nitride have also been identified as alternate materials for these applications.

Various shapes have been proposed for ceramic discharge vessels ranging from a right circular cylindrical shape to an approximately spherical (bulgy) shape. Examples of these types of ceramic discharge vessels are given in European Patent Application No. 0 587 238 A1 and U.S. Pat. No. 5,936,351, respectively. The bulgy shape with its hemispherical ends is preferred because it yields a more uniform temperature distribution, resulting in reduced corrosion of the discharge vessel by the fill materials, in particular metal halide salt fills. A cross-sectional illustration of a bulgy-shaped ceramic discharge vessel that has been fitted with electrodes, filled and sealed is shown in FIG. 1.

One common feature that exists in ceramic discharge vessels for metal halide discharge lamps is protruding capillaries that have small diameter bores. As shown in FIG. 1, the capillaries 2 extend outwardly from the hollow body 6 of the discharge vessel 1. The capillaries are adapted to receive an electrode 3 which is subsequently hermetically sealed to the capillary with a frit material 9, such as Al₂O₃—SiO₂—Dy₂O₃. A major function of the capillaries is to locate the frit seals far enough away from the arc discharge in discharge chamber 12 so that the frit seals are maintained at a lower temperature during lamp operation. This in turn reduces the potential for corrosion of the frit material by reactions with the metal halide salts 8.

Ceramic discharge vessels may be made using a number of ceramic fabrication processes including extrusion, isostatic pressing, slip casting, injection molding and gel casting. The common element in these processes is the need to design and fabricate tooling, dies or molds utilized in the forming of the various ceramic components. In the development of new lamp applications, this can add significant time and cost to the process, particularly when several design iterations are required to achieve a lamp with the desired combination of life, light quality and efficacy. It would be therefore advantageous to have a method of making a ceramic discharge vessel that did not require the use of molds or dies.

Stereolithography has been known to form high-density alumina ceramics without utilization of expensive molds (See, e.g., U.S. Pat. No. 6,117,612 and G. Brady et al., Differential Photocalorimetry of Photopolymerizable Ceramic Suspensions, J. Materials Science, 33 (1998) 4551-60.) In principle, stereolithography builds a component layerwise from a reservoir of a liquid monomer (e.g., epoxide or acrylate resins) by local hardening of the monomer, typically with ultraviolet (UV) laser radiation. In particular, one literature reference teaches that for the manufacture of high density Al₂O₃ ceramics mixtures the following composition may be used: (i) 50 vol. % (20 wt. %) UV-cureable acrylate resin, e.g., 1,6-hexanediol diacrylate (Photomer® 4017 Cognis GmbH), (ii) 50 vol. % (80 wt. %) Al₂O₃ powder with a mean grain size (d₅₀) between 0.3 μm and 0.6 μm, and (iii) 0.5 wt % photoinitiator, e.g., Irgacure 184 (Ciba GmbH). The amount of the photoinitiator is based on the resin part. A dispersant is added to reduce the viscosity of the mixture, e.g., 2 wt. % quaternary ammonium acetate based on the Al₂O₃ part (Emcol CC-55 from Witco Corp.). A solvent, e.g., decahydronaphthalene (Decalin), may also used in order to additionally reduce the viscosity of the mixture. The green ceramic component is manufactured in a stereolithography machine by means of a UV-laser at a dose of 1500 mJ/cm² and a cure depth of 300 μm-400 μm. Subsequently the green component is heated slowly in air (1 K/min) to 600° C.-800° C., in order to thermally remove the cured acrylate resin. A subsequent sintering at 1600° C. yields an Al₂O₃-ceramic with high final density. However, the exact density values as well as degree of optical translucency are not stated.

### SUMMARY OF THE INVENTION

A method of manufacturing a ceramic discharge vessel for a lamp application is described. The method uses a low viscosity suspension of ceramic powder in a liquid resin. The discharge vessel is formed layer by layer using a stereolithography system. Preferably, the layers are formed by locally exposing the ceramic-resin mixture to a light source, e.g., a UV laser, that solidifies and cures the resin only in the areas which correspond to the particular cross-sectional profile of the discharge vessel for a respective layer.

After the final layer is solidified, the green shape of the discharge vessel is removed from the stereolithography apparatus and any uncured ceramic-resin mixture is rinsed from the piece. Preferably, the resin in the green shape is then further cured, in particular, by exposure to ultraviolet light. The shaped discharge vessel is then placed in an oven and heated above the decomposition point of the cured resin to remove it and leave a pre-sintered shape of the discharge vessel. The pre-sintered shape is heated in a furnace to sinter the ceramic material to a high density and translucency sufficient for lighting applications.

A major advantage of the invention is that the ceramic discharge vessel is formed without the need for any dies or molds to form the shape. This results in a reduction in time and expense in the fabrication of new discharge vessel designs. The process further allows for the design of more complex discharge vessel shapes which may be impossible or impractical by conventional ceramic-forming processes.

In accordance with one aspect of the invention, there is provided a method of making a ceramic discharge vessel, comprising: (a) forming a mixture of a ceramic powder, a dispersant, a photoinitiator, and a resin, the mixture having a solids content of at least about 45 volume percent and a viscosity of less than about 50,000 mPa·s; (b) forming a green body having the general shape of the discharge vessel by localized curing of the resin mixture; (c) heating the green body first in an inert atmosphere at a temperature from about 500° C. to about 600° C. followed by heating in an oxygen-containing atmosphere at a temperature from about 500° C. to about 1350° C. to remove the cured resin and form a presintered body; (d) sintering the presintered body to form the ceramic discharge vessel.

In accordance with another aspect of the invention, there is provided a ceramic-resin mixture for forming ceramic discharge vessels by stereolithography, the mixture consisting of a homogeneous dispersion of a ceramic powder, a dispersant, a photoinitiator, and a resin, the mixture having a solids content of at least 45 volume percent and a viscosity of from about 200 to about 25,000 mPa·s

### BRIEF DESCRIPTION OF THE DRAWINGS

FIG. 1 is a cross-sectional illustration of a completed ceramic discharge vessel that has been fitted with electrodes, filled and sealed.

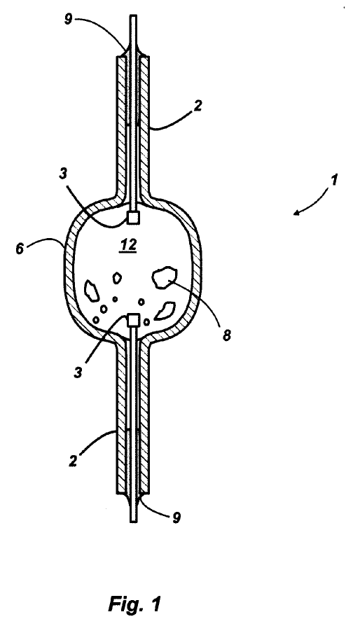

FIG. 2 is a cross-sectional illustration of a shape for ceramic discharge vessel.

FIGS. 3a-c are a schematic illustration of a stereolithography process.

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

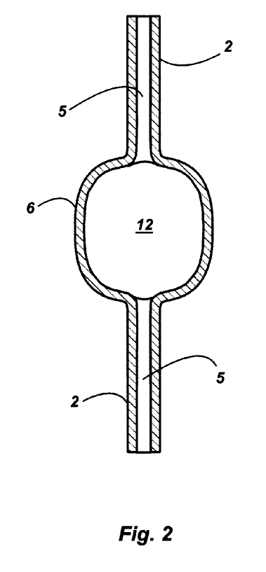

As described previously, stereolithography (SL) has been used to make aluminum oxide ceramics. However, until now, it had not been used to make ceramic discharge vessels for lighting applications. One dilemma that has been solved by the present invention is the creation of a low viscosity ceramic-resin mixture for stereolithography that contains a high solids content. A low viscosity is required so that any residual ceramic-resin mixture that becomes trapped inside the internal cavity that comprises the discharge chamber 12 of the discharge vessel can be drained through the narrow bore 5 of the capillary tubes 2 as exemplified in FIG. 2. The high solids content is needed in order to form a green ceramic shape that can be sintered to translucency and a high final density.

The ceramic-resin mixture of the present invention has the further advantage that it does not require the use of a solvent to reduce viscosity. This eliminates the potential for viscosity changes in the ceramic-resin mixture due to solvent volatilization during processing. Furthermore the ceramic-resin mixtures should exhibit a good curing behavior and yield a cured shape of a high surface quality. The cured resins must also be able to be decomposed without disrupting, cracking or blistering the discharge vessel shape or leaving undesired residue behind after decomposition.

Preferably, the resin used in the ceramic-resin mixture is a photocureable acrylate resin, such as Photomer® 4006 from Cognis GmbH. Preferred ceramic powders include aluminum oxide, aluminum oxynitride, yttrium aluminum garnet, and aluminum nitride powders. The solids content of the ceramic-resin mixture is preferably at least about 45 vol. % and more preferably about 45 vol. % to about 60 vol. %. A dispersant is added to achieve the high solids content and lower viscosity. The amount of the dispersant is preferably about 2 to about 4 wt. % based on the weight of the ceramic powder. More preferably the amount of the dispersant is about 4 wt. % based on the weight of the ceramic powder. A preferred dispersant is Disperbyk-180 (Byk Chemie GmbH) which is described by the manufacturer as an alkylolammonium salt of a block copolymer with acidic groups. The dispersing effect of Disperbyk-180 is much stronger than that of the quaternary ammonium acetate dispersant used in the prior art method described earlier. No sedimentation of the powder particles could be observed in the acrylate resin unlike as could be detected with the use of the quaternary ammonium acetate dispersant. Preferably, the viscosity of the ceramic-resin mixture is no greater than about 50,000 mPa·s and preferably in the range of about 200 to about 25,000 mPa·s.

To obtain the maximum dispersive effect, it is preferred that the ceramic powder particles be coated with the dispersant prior to adding the powder to the resin. This can be achieved by suspending the ceramic powder in a solution of the dispersant and then drying the wet mixture. The dried mixture is then added to the photocurable acrylate resin.

A series of ceramic-resin mixtures were prepared with different photocurable resins. The results of viscosity measurements on the mixtures are presented in the following table. In each case, the mixture contained 45 volume percent aluminum oxide powder (Baikowski CR-6) and Disperbyk 180 (Byk Chemie GmbH) as a dispersant.

| | wt. % | Viscosity |
|---|---|---|
| Resin | dispersant | (mPa · s) |
| Acrylate (Photomer ® 4006) | 2 | 25000 |
| Acrylate (Photomer ® 4006) | 4 | 17000 |
| Acrylate (Photomer ® 4017) | 4 | 2000 |
| Epoxy 61C | 2 | 93000 |
| Epoxy 61C | 4 | 142000 |

The mixtures using liquid acrylate resins had significantly lower viscosities and were therefore more desirable for forming ceramic discharge vessel shapes. Tests of the UV curing behavior of the mixtures suggested that although the mixture made using the Photomer® 4017 acrylate resin (Cognis GmbH) was the lowest in viscosity, the Photomer® 4006 acrylate resin (Cognis GmbH) appeared to provide more desirable mechanical properties after curing. The mixtures using Epoxy 61 C (DSM Somos) were deemed to be too high in viscosity for draining through the small capillary bores in the formed discharge vessels.

After preparation of the ceramic-resin mixture, discharge vessel shapes are produced by a stereolithography process. It should be noted that stereolithography machines are conventional and commercially available and stereolithography processes for making plastic prototypes are well known. As such, it is not necessary for an understanding of this invention to describe the stereolithography apparatus in other than general terms.

Just prior to the stereolithography process, a photoinitiator is added to the ceramic-resin mixture. A preferred photointiator for UV curing is DAROCUR® 4265 (Ciba Specialty Chemicals) which is a mixture of 50% 2,4,6-trimethylbenzoyl-diphenyl-phosphineoxide and 50% 2-hydroxy-2methyl-1-phenyl-propan-1-one. The photoinitiator is preferably added in an amount from about 0.3 to about 3.0 wt. % of the resin.

In general, the stereolithography process starts with a computerized model of the desired discharge vessel shape to be created. This computer file is then used in the stereolithography apparatus to form the desired shape and, optionally, an appropriate support structure that is preferably removable from the formed shape. The SL machine typically uses a reservoir of the ceramic-resin mixture that contains a platform that can be lowered in controlled steps through the reservoir height. The focal point of the UV light source can be controlled by the SL machine to allow patterns to be traced on the surface of the resin mixture in order to selectively cure the resin. In an alternative method, another SL machine illuminates a thin bath of a resin mixture from underneath with a visible light source. In this case, the shape is grown out of the resin mixture instead of being submerged into a large reservoir. This reduces the amount of resin mixture needed for the process and reduces the drainage issues that are inherent in the submersion technique. Other SL machines may employ a coating/stripper method to apply each layer.

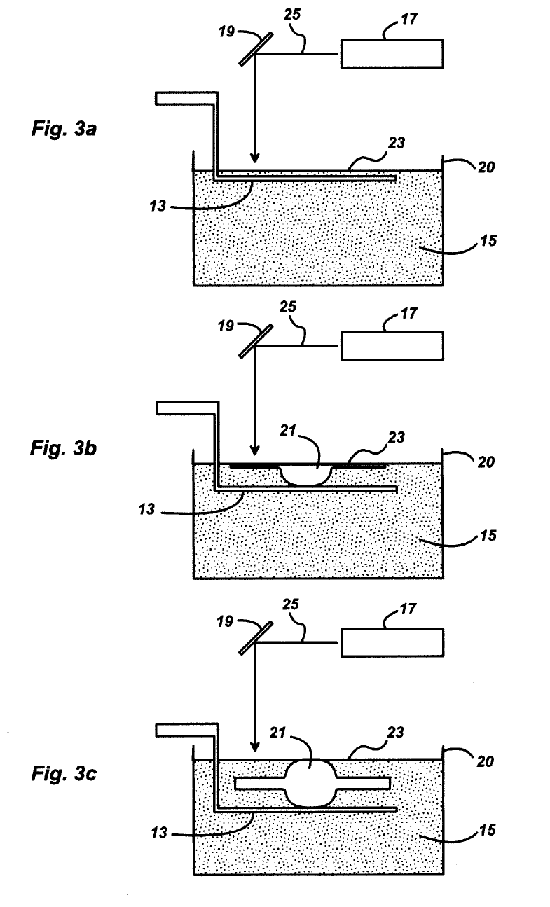

In practice, the computerized model of the discharge vessel is divided into thin cross-sectional layers within the software. The shape of each layer is then sent to the SL machine for fabrication. A general illustration of a preferred SL process is shown in FIGS. 3a-c. For the first layer (FIG. 3a), the platform 13 is positioned at the surface 23 of the liquid resin/ceramic mixture 15 and is lowered one layer thickness (typically 10 to 100 micrometers) into the reservoir 20. The liquid resin/ceramic mixture 15 flows over the platform 13, and the beam 25 of UV laser 17 is scanned across the surface by mirror mechanism 19 to cure and solidify the ceramic-resin mixture in the shape of the first cross-sectional layer of the computerized model. At a penetration depth of 150-400 μm and a laser output of 2.0 mW to 13.0 mW, laser radiation with a focus point of 45-90 μm can be utilized at a scanning speed of 50-200 mm/s. Higher scanning speeds up to 1000 mm/s are also possible.

The platform is then lowered into the reservoir by another layer thickness causing the liquid resin mixture to flow over the cured layer on the platform. The UV laser is then used to cure and solidify the second layer on top of the first according to the shape determined from the sliced computerized model. The platform again lowers into the reservoir by another layer thickness, allowing more of the liquid ceramic-resin mixture to flow over and coat the surface of the newly formed layer. FIG. 3b illustrates the state of the discharge vessel 21 approximately midway through the forming process.

The recoating and UV solidification of each layer is repeated until the shape of the discharge vessel 21 has been reproduced within the reservoir as illustrated in FIG. 3c. The platform is then raised to allow removal of the formed discharge vessel shape. Any residual liquid ceramic-resin mixture is allowed to drain from the internal cavity and the shape is rinsed with a solvent such as propanol to clean the surfaces of the uncured ceramic-resin mixture. Following cleaning, the shape is often placed in a UV oven to assure complete curing of the resin. The formed shape now in its green state is then ready for further processing.

It should be noted that, although the discharge vessel shape is shown as being grown horizontally in FIGS. 3a-c, it is preferred that the vessel should be grown vertically even though this substantially increases the number of layers in the stereolithography process. The horizontally oriented discharge vessel exhibited noticeable “stair steps” between formed layers, which could lead to sealing stresses on the inside diameters of the capillary extensions during lamp fabrication. In addition, it is possible to fabricate support structures simultaneously with the discharge vessel during the stereolithography process which can be removed prior to sintering the discharge vessel.

Prior to sintering the green shape to form the discharge vessel, the cured resin must be removed. In this respect, it was found desirable to use a two-step thermal process to remove the cured resin. The two-step thermal debind process used an initial heating in an inert atmosphere, preferably nitrogen gas, at about 500° C. to about 600° C. to decompose the organic resin. This was followed by heating in an oxygen-containing atmosphere at about 500° C. to about 1350° C., and more preferably about 850° C. to about 1150° C., to remove the residual carbon from the prior decomposition step. The parts may be cooled between heating steps or may proceed directly to the second heating step while still hot. This two-step process was found to minimize disruption and cracking of the shape.

After the two-step binder removal process, the resulting pre-fired shape was heated to a temperature from about 1800° C. to about 1850° C. (preferably 1830° C.) in a hydrogen atmosphere to sinter the shape to full density and achieve a high degree of translucency suitable for lighting discharge vessel applications.

### EXAMPLE

A liquid ceramic-resin mixture of 45 vol. % (25.4 wt. %) Al₂O₃ and 55 vol. % (74.6 wt. %) arcylate resin was used in the stereolithography process. The Al₂O₃ powder had a mean grain size, d₅₀=0.6 μm. The acrylate resin was Photomer® 4006 from Cognis GmbH which is a highly functionalized trimethylolpropane triacrylate. This resin is preferred because it offers a better curing behavior as well as a higher density and better surface quality of the cured shape.

Prior to mixing with the acrylate resin, the Al₂O₃ powder was coated with 4 wt. % Disperbyk-180 (Byk Chemie) dispersant by dissolving the dispersant in distilled water and adding the Al₂O₃ powder gradually under constant stirring. The suspension was dried thereafter at 60° C.-80° C. in a drying oven until the water was completely removed. The dried mass was then finely ground and sieved, in order to separate large agglomerates.

The dispersant-coated Al₂O₃ powder was then dispersed in the acrylate resin while stirring at a speed of 1200-1400 revolutions/minute. The mixture was subsequently milled and homogenized for several hours with a ball mill. Just before the stereolithography process, 0.3 wt. % of DAROCUR® 4265 photoinitiator (Ciba Specialty Chemicals) was added to the liquid ceramic-resin mixture. The ceramic-resin mixture exhibited a viscosity of 17000 mPa·s and could be processed in the stereolithography machine without difficulty.

The green shapes were manufactured by means of stereolithography with a UV-laser (Cd—He). The laser power amounted to 2.8 mW at a curing depth of 350 μm. After the cleaning, the green shapes were further cured in a UV chamber having from six to ten 40 watt lamps. This post-curing step was conducted in two 30 minute intervals, wherein the green shapes were rotated about 180° after the first interval in order to obtain uniform curing.

The cured resin was removed slowly in a two-step debind process. In the first step, the green shapes were heated in nitrogen to about 600° C. at a rate of about 1 K/min and held at that temperature for about one hour. In the second step, the shapes were heated in an oxygen atmosphere to about 1150° C. at a rate of about 1 K/min and held at that temperature for about one hour. This was followed by cooling the shapes to room temperature at rate of about 2 K/min. After the resin binder was removed, no cracks, spalling or distortion of the pre-sintered shapes could be detected.

The pre-sintered shapes were sintered subsequently at about 1800° C. to about 1850° C. under a H₂ atmosphere. After sintering, a high sinter density (>99.8% of theoretical density) and good translucency was achieved.

While there have been shown and described what are present considered to be the preferred embodiments of the invention, it will be apparent to those skilled in the art that various changes and modifications can be made herein without departing from the scope of the invention as defined by the appended claims.

What is claimed is:

1. A method of making a ceramic discharge vessel, comprising:
(a) forming a mixture of a ceramic powder, a dispersant, a photoinitiator, and a resin, the mixture having a solids content of at least about 45 volume percent and a viscosity of less than about 50,000 mPa·s;
(b) forming a green body having the general shape of the discharge vessel by localized curing of the resin mixture;
(c) heating the green body first in an inert atmosphere at a temperature from about 500° C. to about 600° C. followed by heating in an oxygen-containing atmosphere at a temperature from about 500° C. to about 1350° C. to remove the cured resin and form a presintered body;
(d) sintering the presintered body to form the ceramic discharge vessel.

2. The method of claim 1 wherein the green shape is formed in multiple layers wherein each layer represents a cross section of the discharge vessel.

3. The method of claim 1 wherein the resin is an ultraviolet-curable resin and the green shape is further cured after solvent cleaning by exposing the green body to ultraviolet radiation.

4. The method of claim 1 wherein the viscosity of the mixture is from about 200 to about 25,000 mPa·s.

5. The method of claim 1 wherein the ceramic powder is comprised of at least one of aluminum oxide, aluminum oxynitride, yttrium aluminum garnet, or aluminum nitride.

6. The method of claim 1 wherein the resin is an acrylate resin and the dispersant is present in an amount from about 2 wt. % to about 4 wt. % of the ceramic powder.

7. The method of claim 1 wherein the mixture has a solids content of about 45 vol. % to about 60 vol. %.

8. The method of claim 1 wherein the ceramic powder is coated with the dispersant prior to forming the mixture.

9. The method of claim 1 wherein the heating in an oxygen-containing atmosphere occurs at a temperature from about 850° C. to about 1150° C.

10. The method of claim 1 wherein the discharge vessel is formed in a vertical orientation.

11. The method of claim 1 wherein the presintered body is sintered in a hydrogen atmosphere at a temperature from about 1800° C. to about 1850° C.

12. A ceramic-resin mixture for forming ceramic discharge vessels by stereolithography, the mixture consisting of a homogeneous dispersion of a ceramic powder, a dispersant, a photoinitiator, and a resin, the mixture having a solids content of at least 45 volume percent and a viscosity of from about 200 to about 25,000 mPa·s.

13. The ceramic-resin mixture of claim 12 wherein the resin is an acrylate resin and the dispersant is present in an amount from about 2 wt. % to about 4 wt. % of the ceramic powder.

14. The ceramic-resin mixture of claim 13 wherein the ceramic powder is aluminum oxide and the dispersant is an alkylolammonium salt of a block copolymer with acidic groups.

15. The ceramic-resin mixture of claim 12 wherein the resin is a highly functionalized trimethylolpropane triacrylate.

16. The ceramic-resin mixture of claim 12 wherein the solids content is from about 45 vol. % to about 60 vol. %.

17. The ceramic-resin mixture of claim 13 wherein the mixture contains about 0.3 weight percent to about 3 weight percent of the photoinitiator based on the weight of the resin.

18. The ceramic-resin mixture of claim 13 wherein the mixture does not exhibit any sedimentation of the ceramic powder.

19. The ceramic-resin mixture of claim 12 wherein the ceramic powder is comprised of at least one of aluminum oxide, aluminum oxynitride, yttrium aluminum garnet, or aluminum nitride.

20. A method of making a ceramic discharge vessel having a discharge chamber and at least one capillary tube, comprising:
(a) forming a mixture of an aluminum oxide powder, a dispersant, a photoinitiator, and an acrylate resin, the mixture having a solids content of about 45 volume percent to about 60 volume percent and a viscosity of about 200 mPa·s to about 25,000 mPa·s;
(b) forming a green body having the general shape of the discharge vessel by localized curing of the resin mixture in multiple layers that each correspond to a respective cross section of the discharge vessel;
(c) cleaning the green body with a solvent to remove residual uncured mixture;
(d) heating the green body first in an inert atmosphere at a temperature from about 500° C. to about 600° C. followed by heating in an oxygen-containing atmosphere at a temperature from about 850° C. to about 1150° C. to remove the cured resin and form a presintered body;
(e) sintering the presintered body at a temperature from about 1800° C. to about 1850° C. in a hydrogen atmosphere to form the ceramic discharge vessel.
